(19) United States
(12) Patent Application Publication
(10) Pub. No.: US 2018/0069816 A1
(43) Pub. Date: Mar. 8, 2018

(54) System and method for creating an electronic document and sending it to one or more email addresses using 1 click send.

(71) Applicant: Thien Pham, Lacey, WA (US)

(72) Inventor: Thien Pham, Lacey, WA (US)

(73) Assignees: Synergex Group, Greenwhich, CT (US); Wayne Taylor, Chandler, AZ (US); Pham Holdings, Lacey, WA (US)

(21) Appl. No.: 15/258,294

(22) Filed: Sep. 7, 2016

(51) Int. Cl. H04L 12/58; G06F 17/27

(52) U.S. Cl. CPC H04L 51/14; H04L 51/28; H04L 51/22; G06F 17/2705

(57) ABSTRACT

System and method for creating an electronic document and sending it to one or more email addresses using 1 click send.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to a computer program that enables a user to create an electronic document and send it to one or more email addresses enclosed by key strings within the electronic document with a 1 click send button.

### BACKGROUND OF THE INVENTION

Creating electronic documents have been around since the creation of computers. People create electronic documents to share with others. To share a document, people first compose the document, save the document, and then use their personal email to send it. This takes many steps to accomplish.

What is needed is a system and method for creating an electronic document with a 1 click send.

### BRIEF SUMMARY OF THE INVENTION

In a typical application, a user creates an electronic document using a What-You-See-Is-What-You-Get (WYSIWYG) editor. Inside the WYSIWYG editor, the user places one or more email addresses within key strings. An example is <email>user@something.com<email>. <email> is a key string. Key strings can be one or more characters. An example is [user@something.com]. [and] are key strings. Once the user is done with creating the electronic document, the user then clicks a send button. The program then parses the electronic document by scanning for email addresses that are enclosed by key strings, saves the electronic document as a file and store it to computer memory or database server, creates an email containing a link to access the electronic document that is stored in computer memory or database server, and sends the created email to email addresses that are enclosed by key strings within the electronic document.

### BRIEF DESCRIPTION OF THE SEVERAL VIEWS OF THE DRAWING

FIG. 1 is an exemplary screen shot for creating an electronic document with a send button.

FIG. 2 is a flow diagram of an exemplary process for 1 click send.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

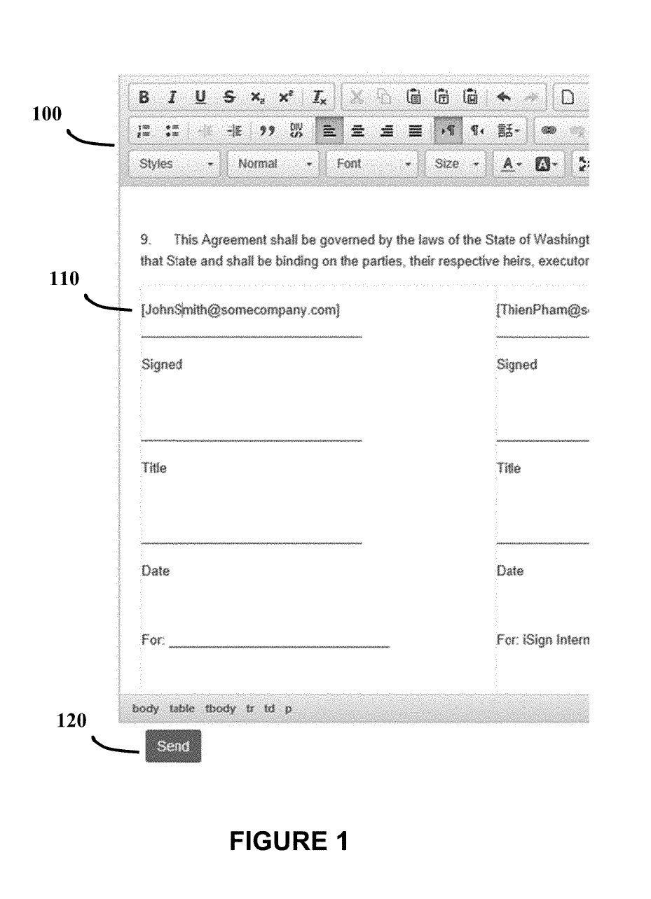

FIG. 1 is an exemplary screen shot for creating an electronic document with a send button.

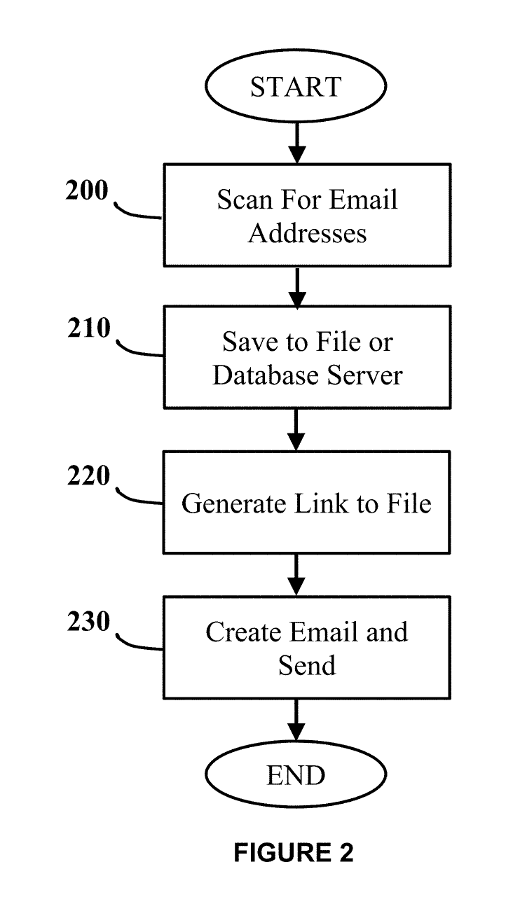

FIG. 2 is a flow diagram of an exemplary process for 1 click send.

A system and method for a 1 click send to share an electronic document by creating an electronic document with email addresses enclosed by key strings, saving the electronic document as a file and storing it to computer memory or database server, creating an email with link to the electronic document stored in computer memory or database server, and sending the created email to email addresses enclosed by key strings within the electronic document is provided.

FIG. 1 is an exemplary screen shot for creating an electronic document with a send button. A user uses a What-You-See-Is-What-You-Get (WYSIWYG) editor 100 to create an electronic document. Inside the electronic document, the user places one or more email addresses enclosed by key strings 110. Once the user is done composing an electronic document with WYSIWYG editor 100, the user then clicks the send button 120 to begin the process for scanning the electronic document for email addresses enclosed by key strings, saving the electronic document as a file and storing it to computer memory or database server, creating an email with links to the electronic document stored in computer memory or database server, and sending the created email to email addresses that were scanned in the electronic document that are enclosed by key strings.

Referring now to FIG. 2, a flow diagram of an exemplary process for 1 click send is provided. At step 200, the program scans the electronic document created by the WYSIWYG editor 100 for email addresses enclosed by key strings and stores it in memory for later use. Key strings can be one or more characters (e.g. [,], /, <email>, etc.). Example emails enclosed by key strings are [user@something.com] and <email>user@something.com<email>. [,], and <email> are key strings. Next the program proceeds to step 210 where it saves the electronic document as a file stored in computer memory or database server and proceeds to step 220. At step 220, the program generates a link to the file stored in computer memory or database server and proceeds to step 230. At step 230, the program creates an email with the generated link to the file in step 220 and sends the email to the scanned email address at step 200 that were stored in memory.

Although the process for 1 click send of an electronic document to email addresses enclosed in key strings of an electronic document is described as being comprised of various steps (e.g., scanning email address 200, saving electronic document as a file stored in computer memory or database server 210, generating a link to the file stored in computer memory or database server 220, creating an email with the generated link to the file and sending the created email 230), fewer or more steps may comprise the process and still fall within the scope of various embodiments.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A method for sending an electronic document to one or more email addresses using 1 click send comprising the steps of:
(a) scanning the electronic document for email addresses enclosed by key strings and storing them in computer memory
(b) saving the electronic document as a file and storing it to computer memory or database server
(c) generating a link to the electronic document stored in computer memory or database server at Step (b)
(d) creating an email with the generated link at Step (c)
(e) sending the created email at Step (d) to the email addresses enclosed by key strings that were stored in computer memory at Step (a)

2. The method of claim 1, wherein key strings are one or more characters

3. The method of claim 1, wherein email address is enclosed by key strings

4. A system for creating an electronic document with a 1 click send comprising:
(a) a What-You-See-Is-What-You-Get (WYSIWYG) editor
(b) a send button
(c) a send module that scans the electronic document created by the WYSIWYG editor, saves the electronic document as a file and stores it to computer memory or database server, generates a link to the electronic document stored in computer memory or database server, creates an email with the generated link to the electronic document stored in computer memory or database server, and sends the created email to email addresses enclosed by key strings
